(19) United States
(12) Patent Application Publication
(10) Pub. No.: US 2021/0371344 A1
(43) Pub. Date: Dec. 2, 2021

(54) CHOPPED GLASS FIBERS FOR CERAMICS

(71) Applicant: Owens Corning Intellectual Capital, LLC, Toledo, OH (US)

(72) Inventor: David R. Hartman, Granville, OH (US)

(21) Appl. No.: 17/287,175

(22) PCT Filed: Oct. 7, 2019
(86) PCT No.: PCT/US19/54925

§ 371 Date: Apr. 21, 2021

Related U.S. Application Data
(60) Provisional application No. 62/750,916, filed on Oct. 26, 2018.

(51) Int. Cl. C04B 33/36; C04B 35/82

(52) U.S. Cl. CPC C04B 33/36; C04B 35/82; C04B 2235/5264; C04B 2235/526; C04B 2235/5216

(57) ABSTRACT

A ceramic article formed from a plurality of materials, the ceramic article being characterized by the addition of glass fibers having a certain length, diameter and aspect ratio and a method for forming a ceramic article.

### CROSS-REFERENCE TO RELATED APPLICATIONS

This application claims priority to and any benefit of U.S. Provisional Patent Application No. 62/750,916, filed Oct. 26, 2018, the entire content of which is incorporated herein by reference.

### FIELD

The general inventive concepts relate to fiber-reinforced materials and, more particularly, to ceramic materials having enhanced mechanical properties as a result of the addition of chopped glass fibers.

### BACKGROUND

Ceramics are non-metallic solids comprising an inorganic compound of metal, non-metal, or metalloid atoms primarily held in ionic and covalent bonds, with common examples being earthenware, porcelain, and brick. Ceramic materials are brittle, hard, strong in compression, and weak in shearing and tension. Ceramic materials resist chemical erosion. In general, ceramic materials can withstand very high temperatures (e.g., 1,000° C. to 1,600° C.).

The applications for ceramic materials are many and varied. One such use is in the production of “sanitaryware,” which generally refers to ceramic plumbing fixtures (e.g., sinks, tubs, toilet bowls). A problem in the production of sanitaryware is that yields can be as low as 50% due to residual stress cracking of the ceramic material during drying and firing combined with damage incurred during handling. Thus, major producers of sanitaryware may have to account for a scrap level upwards of 20%.

Past work on the use of high strength, high thermal resistant glass fibers (e.g., S-glass fibers) to improve the mechanical properties of unfired slip cast, extruded, or injection molded ceramics, also demonstrated improved fracture toughness during firing and subsequent use in the ceramic article. This technology led to commercial sales in ceramic hob stove elements and porcelain dinnerware where it was affordable.

There remains an unmet need for improved and/or lower cost solutions for increasing the yield and/or enhancing the performance of ceramic materials through the addition of glass fibers.

### SUMMARY

It is proposed herein to provide glass fibers for enhancing the properties of ceramic materials.

In one exemplary embodiment, a ceramic article formed from a plurality of materials is enhanced by the addition of glass fibers to the materials, wherein the glass fibers have an average fiber length in the range of 0.38 mm to 6.5 mm; wherein the glass fibers have an average fiber diameter in the range of 10 μm to 25 μm; and wherein the glass fibers have an average aspect ratio greater than 100. In some exemplary embodiments, the glass fibers have 0.15% to 0.5.% by dry weight of sizing solids. In some exemplary embodiments, the glass fibers have a moisture content of 6% to 12%.

In some exemplary embodiments, the materials form a slurry. In some exemplary embodiments, the slurry includes 20-30% ball clay, 25-35% kaolin, 30-35% feldspar, and 15-20% flint, as well as 25-28 wt. % water content.

In some exemplary embodiments, the glass fibers constitute 0.3 wt. % to 0.7 wt. % of the materials. In some exemplary embodiments, the glass fibers constitute 0.5 wt. % of the materials.

In some exemplary embodiments, the glass fibers are made from ECR glass. In some exemplary embodiments, the glass fibers are made from H glass. In some exemplary embodiments, the glass fibers are made from R glass. In some exemplary embodiments, the glass fibers are made from S glass.

In one exemplary embodiment, a method of forming a ceramic article from a plurality of materials is disclosed. The method comprises adding glass fibers to the materials; mixing the materials to distribute the glass fibers within the materials; and drying the materials to form the ceramic article, wherein the glass fibers have an average fiber length in the range of 0.38 mm to 6.5 mm; wherein the glass fibers have an average fiber diameter in the range of 10 μm to 25 μm; and wherein the glass fibers have an average aspect ratio greater than 100.

In some exemplary embodiments, the glass fibers have 0.15% to 0.5.% by dry weight of sizing solids.

In some exemplary embodiments, the glass fibers have a moisture content of 6% to 12%.

In some exemplary embodiments, the materials form a slurry, wherein the slurry includes 20-30% ball clay, 25-35% kaolin, 30-35% feldspar, and 15-20% flint, as well as 25-28 wt. % water content.

In some exemplary embodiments, the glass fibers constitute 0.3 wt. % to 0.7 wt. % of the materials. In some exemplary embodiments, the glass fibers constitute 0.5 wt. % of the materials.

In some exemplary embodiments, the glass fibers are made from ECR glass. In some exemplary embodiments, the glass fibers are made from H glass. In some exemplary embodiments, the glass fibers are made from R glass. In some exemplary embodiments, the glass fibers are made from S glass.

It is proposed herein to provide a ceramic material for use in producing a ceramic product, wherein a yield of the product increases (i.e., the resulting scrap decreases) due to the addition of glass fibers into the ceramic material. In some exemplary embodiments, the ceramic product is a sanitaryware article. The general inventive concepts may be extendable to other materials and/or resulting products, such as gypsum molds, sheet molding compound (SMC), and semiconductors.

Numerous other aspects, advantages, and/or features of the general inventive concepts will become more readily apparent from the following detailed description of exemplary embodiments, from the claims, and from the accompanying drawings being submitted herewith.

### BRIEF DESCRIPTION OF THE DRAWINGS

The general inventive concepts, as well as embodiments and advantages thereof, are described below in greater detail, by way of example, with reference to the drawings in which:

FIG. 1 is a graph showing the ceramic glassy volume phase change from 520° C. to 600° C. during de-hydroxylation.

FIG. 2 is a graph showing viscosity profiles across a temperature range of five (5) different glass compositions.

FIG. 3 is a graph showing the impact on viscosity of the addition of glass fibers to a ceramic slip.

FIG. 4 is a graph comparing the stress-strain curves of unreinforced and fiber-reinforced bars.

FIG. 5 is a graph showing the impact on shrinkage of the addition of glass fibers to a ceramic slip.

FIG. 6 is a graph showing a lack of additional shrinkage during the firing process.

FIG. 7 is a diagram showing porcelain composition.

FIG. 8 are micrographs of four (4) porcelain tiles.

FIG. 9 is a graph plotting firing strength versus longitudinal velocity.

FIG. 10 is a graph plotting dynamic Young's modulus versus total porosity.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

The general inventive concepts encompass ceramic materials that have glass fibers added therein and the beneficial properties resulting therefrom. In some exemplary embodiments, the glass fibers have a fiber length within the range of 0.38 mm to 6.5 mm and a fiber diameter within the range of 10 μm to 25 μm, with an aspect ratio (i.e., l/d ratio) of greater than 100. The glass fibers have 0.15 wt. % to 0.5 wt. % dry of sizing solids. The glass fibers have a moisture content of 6% to 12%. Variations within each of these ranges are expected based on the ceramic material being produced and the processing parameters associated therewith.

In some embodiments, the glass fibers can have an average fiber length in the range of 0.05 mm to 6.5 mm. In some embodiments, the glass fibers can have an average aspect ratio in the range of 10-100.

An improved ceramic material includes lower cost glass fibers (for example, as opposed to S-glass fibers) having a particular shape or form with sizing and moisture content different from other commercially available glass fibers. Typically, the characteristics (e.g., glass composition, aspect ratio, length, diameter, sizing, moisture content, and variations thereof) of the glass fibers depend on the ceramic greenware process parameters. The downstream applications of the glass fiber additive for ceramics, clay slip green-ware, glazing, gypsum molds or sheets, or resin modified formulations through cast, sheet, or injection molding, depend on the form and function of the ceramic part including specific attributes by application criteria. The glass fiber composition could include ECR, H, R or S-glass and is generally referred to herein as CeramiTex in describing the structure-property relationships and data analysis presented below.

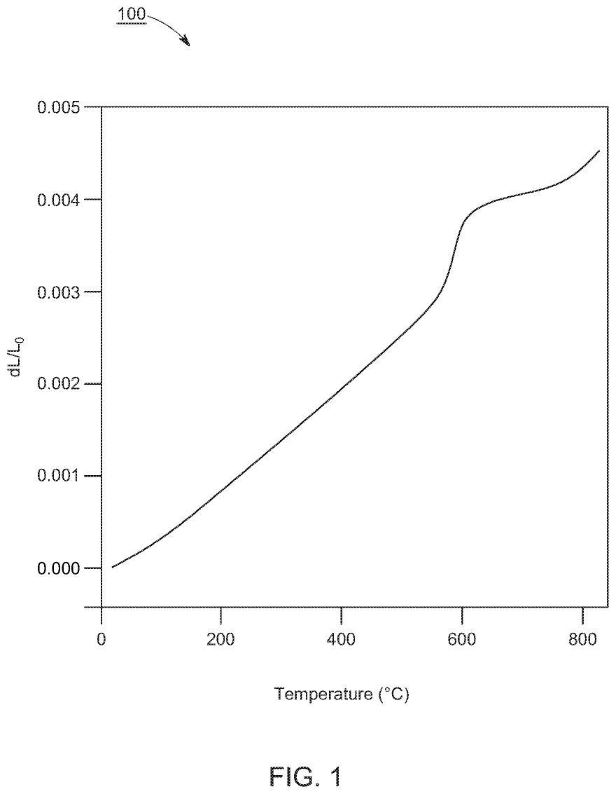

Previously it was demonstrated that lower cost E-glass containing boron was problematic as a ceramic additive, likely due to its lack of dimensional stability at temperatures up to around 520° C. during shrinkage with firing of the greenware. It could also be due to the ceramic glassy volume phase change from 520° C. to 600° C. during de-hydroxylation, as shown by the thermal dilatation curve 100 in FIG. 1. See The role of firing temperature, firing time and quartz grain size on phase-formation, thermal dilatation and water absorption in sanitary-ware vitreous bodies by A. Bernasconi et al., Journal of the European Ceramic Society, Volume 31, Issue 8, July 2011, pages 1353-1360, the disclosure of which is incorporated by reference herein. This will vary somewhat with the ceramic composition and molding/firing process parameters.

Generally, the mechanical properties of unfired cast ceramics are improved by adding 0.5 wt. % glass fibers to the slip. If necessitated by the addition of the glass fibers, a solution of sodium silicate, sodium carbonate, and/or barium carbonate can be used to deflocculate the casting slip to a reasonable working viscosity, thereby promoting more even dispersion of the glass fibers. Typically, the chemistry (i.e., sizing) on the glass fibers aids in fiber dissipation and dispersion in water solution with appropriate shear mixing, the sizing stability prevents fiber re-agglomeration, and with appropriate zeta potential in the clay slurry will not require further additives or deflocculant. Improved toughness of the green body is directly related to the aspect ratio of the added fibers. For example, 10-micron diameter glass fibers at approximately 1.5 mm in length, with an aspect ratio of approximately 150, at 0.5 wt. % loading will produce a significant increase in green body toughness. The reinforced body is resistant to cracking during drying and subsequent handling with the addition of the fibers. The firing shrinkage remains unchanged so that the piece remains in dimensional tolerance. Glass fibers can therefore improve manufacturing yields and allow the production of more complex shapes with minimal effect on the manufacturer's process.

For example, yields for sanitaryware ceramics can be as low as 50% due to residual stress cracking during drying and firing combined with damage incurred during handling. Thus, producers of sanitaryware ceramics can encounter yields of 80% or lower (so scrap levels upwards of 20%). The proposed glass fiber additive is intended to increase the yield rate and, thus, reduce the amount of scrap generated.

A new type of glass fiber, having high dimensional stability and stiffness at drying/firing temperatures, was developed which can be effectively added to the casting slip for higher toughness in the green body. As a result of the glass additive, differential stresses during casting are significantly reduced so that cracks are less likely to form during drying. Because of its unique composition, the fiber fluxes with the ceramic body during firing, resulting in a homogeneous fired ceramic whose composition is almost completely unchanged.

While glass fibers having an average aspect ratio in the range of 10-100 can readily disperse with the clay particulate having an aspect ratio in the range of 5-70 in the glazing process or clay slip process, glass fibers having an average aspect ratio greater than 100 are preferred for obtaining higher green body fracture toughness. For example, the addition of 0.5% dry weight of glass fibers with an aspect ratio greater than 100 to a ceramic slip casting can improve green strength by a factor of 3 to 4, thereby enabling a tenfold reduction in drying time with the potential for 20-50% higher yield of standard slip castings using gypsum tooling for sink basin and toilets.

The glass fibers can be effectively used in various ceramic processes including slip casting, pressure casting, extrusion, injection molding, jiggering, ram pressing, and tape casting. Gypsum molds, which are used in several of these processes, can also be reinforced with the glass fibers. By way of example, the following discussion will focus on the physical properties of reinforced slip cast bodies.

### Materials

S-glass fibers, which have previously been used to reinforce ceramic materials, are magnesium aluminosilicate fibers with a 9 μm diameter. These fibers exhibit a softening temperature of ˜1,050° C. and liquidus temperature of ˜1,500° C. The tensile strength of these fibers exceeds 5 GPa, while the Young's modulus is 88 GPa to 89 GPa. Such S-glass fibers were specifically designed so that additions of less than 1 wt. % are effective in reinforcing ceramic bodies. For most applications, fiber lengths of 1.5 mm are selected so that little change in the current ceramic manufacturing process is required. The higher cost of S-glass fibers have prevented their widespread adoption as an additive to ceramic materials.

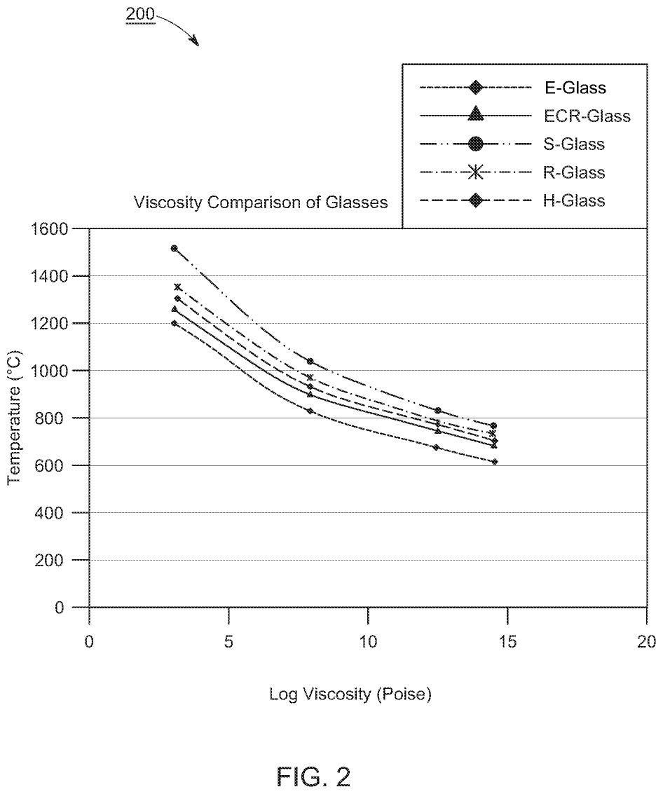

Lower cost ECR-glass and H-glass (or other glasses from the R-glass family) fibers have lower strength and thermal performance than S-glass fibers, but have significantly higher thermal stability, strength, and stiffness than E-glass fibers which previously did not perform well, as shown in the graph 200 of FIG. 2. See also Table 1.

TABLE 1

| PROPERTY | E | ECR | H | R | S |
|---|---|---|---|---|---|
| Bulk Density | 2.626 | 2.664 | 2.615 | 2.549 | 2.452 |
| (g/cm3) | | | | | |
| Modulus (GPa) | 79 | 81 | 88 | 87 | 88 |
| Pristine Tensile | 3,450 | 3,700 | 4,200 | 4,500 | 5,000 |
| Strength (MPa) | | | | | |
| Refractive Index | 1.56 | 1.57 | 1.56 | 1.54 | 1.52 |

The ceramic slips described are typically used in slip casting sanitaryware. They contain 20-30% ball clay, 25-35% kaolin, 30-35% feldspar, and 15-20% flint with water content of 25-28 wt. %. Example 2 of fired greenware for porcelain tile shows the effect of firing temperature on mechanical properties. These trends are assumed to be somewhat similar for porcelain ceramic sanitaryware.

### Manufacturing Process

The inventive fibers are added directly into the slip holding tank (after the slip has been screened). They are introduced to the slip by feeding through a small high shear mixer allowing the bundles to disperse into individual filaments. Following the initial mixing, the standard low shear stirrer of the tank is adequate to distribute the filaments evenly throughout the tank. The individual filaments remain evenly dispersed through the remainder of the process.

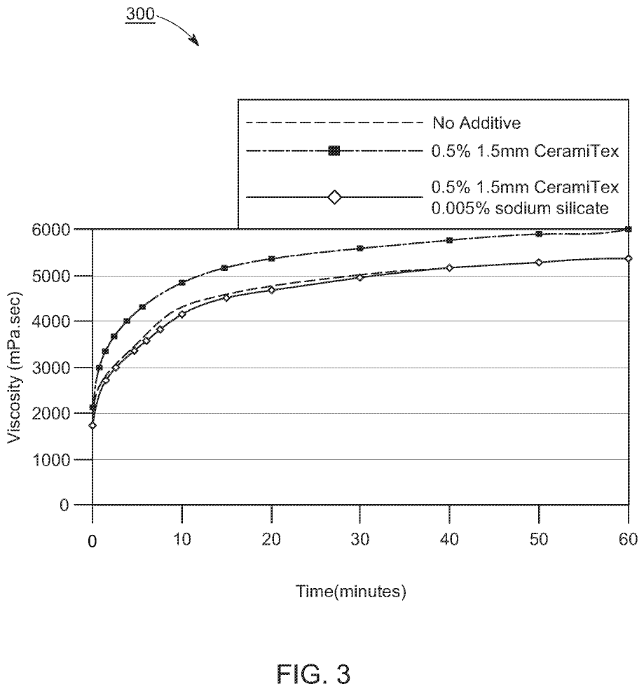

Very small additions of fiber, typically 0.5% by dry weight, are added to the ceramic slip. This results in minimal change to the physical characteristics of the slip. The addition of 0.5% of glass fibers chopped to a length of 1.5 mm results in an approximately 10% increase in viscosity of the slip, as shown in the graph 300 of FIG. 3. As the slip is aged, the proportional increase remains nearly constant. In many cases, the fiber containing slip can be used in casting without any additional modifications. However, upon addition of a small amount of deflocculant, such as sodium silicate and/or barium carbonate, the viscosity can be returned to its original level with no other change in the rheological behavior.

The fiber-containing slip is then cast using standard production techniques. No modifications in the slip delivery system nor in the mold design are required. During mold filling, laminar flow develops in the slip causing the fibers to predominantly align parallel to the mold surface. Depending on the slip and fiber concentration, casting time may be slightly decreased, but is generally unaffected. When the piece is removed from the mold, the appearance of either the cast surface or the drain surface are not distinguishable from those of an unreinforced part.

### Mechanical Properties

When a reinforced piece is fractured, a remarkable difference is observed as compared to the typical green ceramic. Rather than the brittle fracture characteristic of an unreinforced green ceramic, a ductile failure occurs in the fiber-reinforced piece. Upon close inspection of the fracture surface, the surface appears furry. The very low concentration (0.5%) of short filaments (1.5 mm) are distributed evenly throughout the piece effectively to toughen the green ceramic and minimize residual stresses.

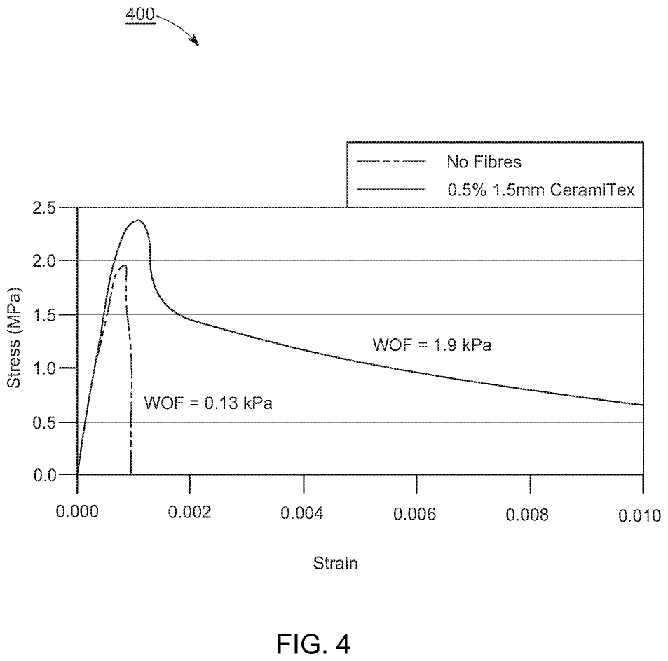

As shown in the graph 400 of FIG. 4, the stress-strain curves of unreinforced and fiber-reinforced bars tested in 3-point flexure are compared. With only 0.5 wt. % loading of fiber, the green ceramic displays ˜20% improvement in flexural strength. More important, though, is the change in failure mode resulting from the presence of fibers. In contrast to the unreinforced ceramic which shows a sudden load drop when it snaps, the reinforced specimen exhibits non-catastrophic failure, retaining load at strains exceeding 0.01%. Consequently, the work of fracture (WOF) in the reinforced bar is significantly higher than that of the unreinforced bar.

The stress-strain data confirms that the low loadings of fiber effectively impart toughness by several mechanisms. These toughening mechanisms include crack deflection, debonding, and frictional sliding at the fiber/matrix interface. In this composite, the fracture energy of the interface, Gi, is sufficiently small compared to the strength of the fiber, Gf, or Gi/Gf<<0.25 so that fiber debonding will occur. Further, frictional sliding of fibers dissipates significant energy because of a compressive residual stress state at the fiber/matrix interface.

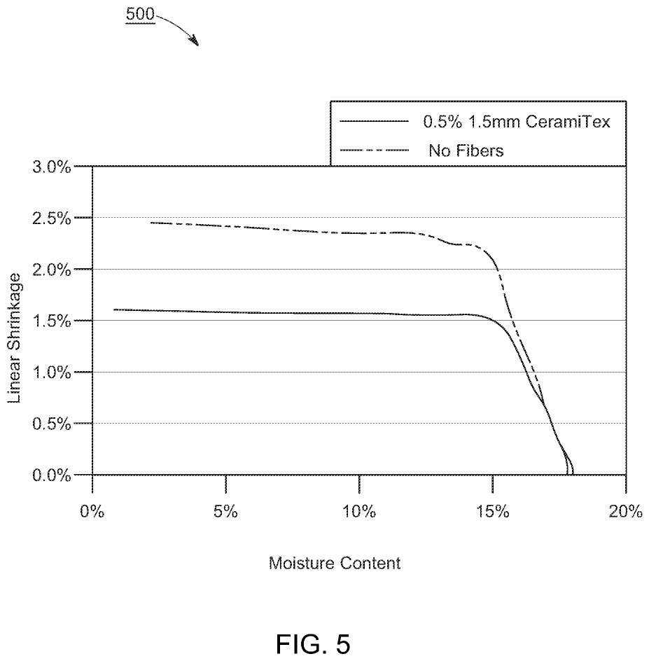

The presence of fibers in the cast body also reduces the shrinkage of the green body during drying. This amounts to a 30% reduction in the linear drying shrinkage observed, or 0.5-0.8% less shrinkage than in the unreinforced body given with change in moisture content, as shown in the graph 500 of FIG. 5. The residual stress is therefore much lower in the fiber-reinforced body. Additionally, sanitaryware with rather complex geometry will have much lower differential stresses throughout.

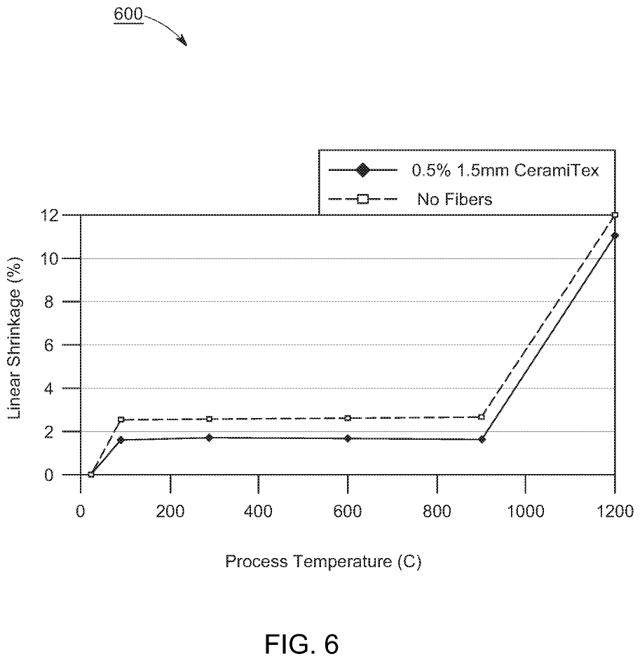

During the firing process, no additional change in body shrinkage is observed from the addition of the fibers, as shown in the graph 600 of FIG. 6. When measuring the overall shrinkage of the body, the reduction in green shrinkage is quite small <1% so that the fired ceramic piece remains within dimensional tolerances.

In the case of the green ceramic, the reduction in residual stress and the combination of energy dissipation mechanisms result in a ceramic that is extremely resistant to crack formation during drying. This improvement can be quantified by casting a ceramic specimen in the shape of an “H” and leaving it in the mold throughout drying. Because of the physical constraint of the mold, tensile stresses are induced (analogous to those which develop in complex ceramic sanitaryware). When the body is unreinforced, initiation and subsequent propagation of a crack occur in less than three hours for most ceramic slips. When reinforced with 0.5 wt. % fiber, crack initiation is not observed until 8-10 hours. Furthermore, these cracks remain <2 mm in length and never propagate across the specimen.

### Manufacturing Yields

Because of the demonstrated property improvements, it is apparent that increases in manufacturing yields can be achieved. Ongoing manufacturing evaluations indicate that yields for the cast clay body can increase between 10-20% depending on the how low the yields are without the fiber additive. In certain particularly difficult complex pieces, fiber reinforcement has allowed pieces to be successfully cast when no first time A-grade pieces were produced using the same system without fibers.

Because the reinforced body has a significantly reduced stress level, cracks which can occur during firing may also be improved. As a result, A-grade fired yield improvements of 5-10% are typical. After firing, the microstructure and surface of parts made with these fibers are identical to those without.

### Gypsum Mold Reinforcement

Gypsum molds for slip casting have also been successfully reinforced with fiber. Here, fiber lengths of 3 mm and 6 mm are typically used, resulting in even greater mold strength and toughness. Two basic approaches have been employed with mold reinforcement. The first approach is accomplished by adding fibers to the standard gypsum composition (usually 75 parts water to 100 parts gypsum). This results in improved toughness, improved resistance to cracking, and reduced wear rate. Most importantly, the durability of the mold is improved so that it does not chip nor crack. Even in the case where a small hairline crack is initiated, the fibers effectively bridge the crack to prevent it from propagating, leaving the mold still very usable. With this approach, the lifetime of the mold can be tremendously enhanced.

The second approach involves modification of the mold composition to increase casting rates. This is accomplished by increasing the water content (e.g. 78-80 parts water to 100 parts gypsum). In this case, the strength and toughness of the reinforced mold still exceed those of the unreinforced mold, yet the porosity and dewatering rate are significantly improved. This approach facilitates improvement in the overall casting efficiency of an operation.

### Current Conclusions

Glass fibers have been successfully used to improve the mechanical properties and yield of green ceramics. These improvements come from reduced differential shrinkage enabling a reduction of stress-related cracks during drying and firing. The inclusion of relatively small amounts of glass fiber, within the ceramic molding composition (with appropriate surface treatment to maintain dispersion without agglomeration) facilitates drying of the green body as the glass fiber network diffuses moisture to the surface to help eliminate moisture differentials. This fiber network reduces the linear shrinkage of the green body during drying and firing. Lower stresses from lower moisture differentials and linear shrinkage results in lower crack formation, thereby providing the green body with increased strength and fracture toughness. This enables a more efficient molding process and reduced scrap for improved yield and energy impact. Additionally, the inclusion of these glass fibers, in some ceramic compositions, have the potential to reduce stresses in the fired micro-structure through local enrichment in the composition by the glass fiber flux which toughens regions with stress risers (e.g., double to single wall drop-offs, sharp corners), thereby enhancing design flexibility.

Lower cost solutions are being explored that use less costly glass compositions (e.g., Boron-free ECR glass, H glass), improved chopping processes, and surface treatments for effective dispersion in the clay slip to produce greenware for drying and firing to complex ceramic articles.

The glass composition evaluation is initially focused on ECR glass with higher strain point and higher temperature capability for ceramic firing conditions than E glass. The ECR glass fibers have an aspect ratio defined by their length (0.38 mm to 6.5 mm) and diameter (10 μm to 25 μm); sizing with epoxy, polyamide, PVP, or silicone film-former, and silane-based coupling agent (0.15 wt. % to 0.5 wt. % dry solids); moisture content (6% to 12%), and anticipated variations of each.

Due to several energy absorbing mechanisms, the fiber reinforced green ceramic exhibits a tenfold improvement in toughness and is relatively insensitive to flaws or impact loading. A reduction in drying shrinkage results in lower differential stresses, thereby minimizing the formation of stress cracks. Consequently, manufacturing yields are dramatically improved during both casting and firing operations.

Gypsum molds have also been successfully reinforced with glass fibers. This allows for the production of a tougher, more durable mold. The improved mold strength offers more flexibility when selecting the gypsum mixture, facilitating production of a mold with greatly improved porosity and dewatering rates.

### EXAMPLES

### Example 1—Vacuum Extrusion of Electrical Porcelain Insulator

High voltage insulators are designed with lower flashover voltage (external design limited) than puncture voltage (internal material dielectric strength) to avoid damage. Flash-over arcing occurs along the outside of the insulator without damage before puncture arcing. This is due to breakdown and conduction of the material above its dielectric strength, which causes an electric arc through the interior of the insulator. The heat resulting from the puncture arc damages the insulator beyond repair. Porcelain has a dielectric strength of about 4 kV/mm to 10 kV/mm, but glass has a higher dielectric strength of about 10 kV/mm to 13 kV/mm. Glass is not used because the thick irregular shapes for insulators are difficult to form. However, its higher toughness and dielectric strength as an additive to the porcelain enables higher resistance to puncture arcing. Additionally, the use of glass fibers to reduce drying shrinkage and differential stresses of the complex irregular shapes, can reduce stress cracking and increase yield during shaping and drying of greenware.

### Example 2—Slip Casting or Extrusion of Porcelain Tile

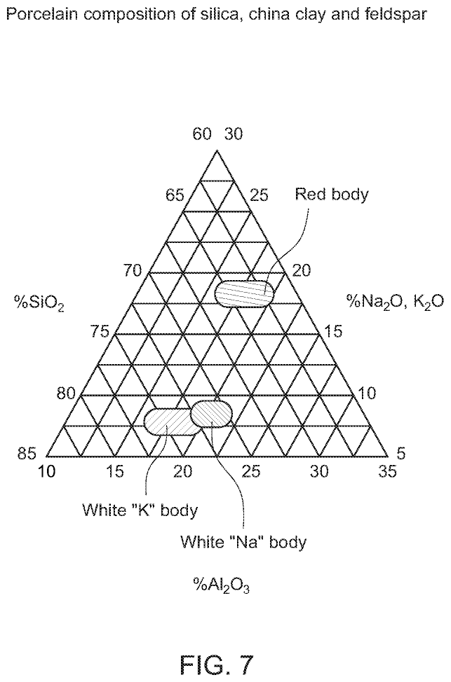

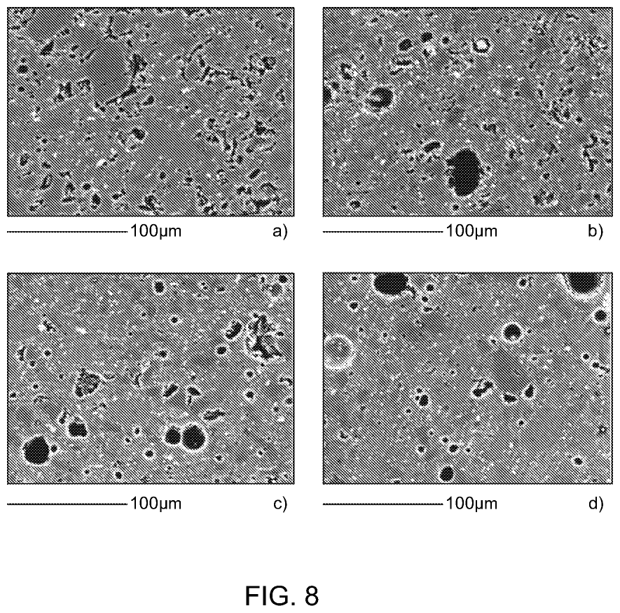

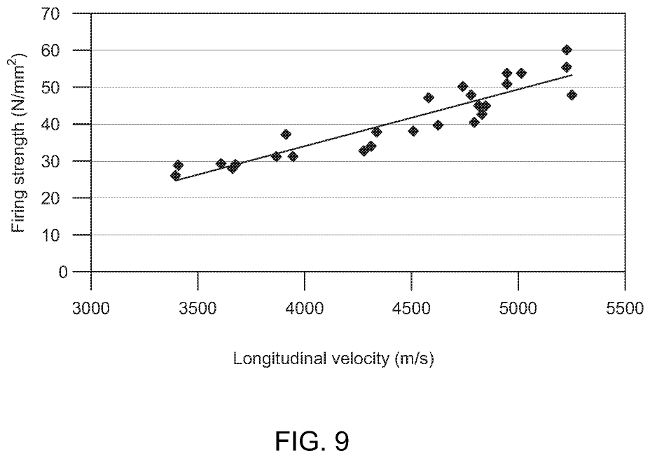

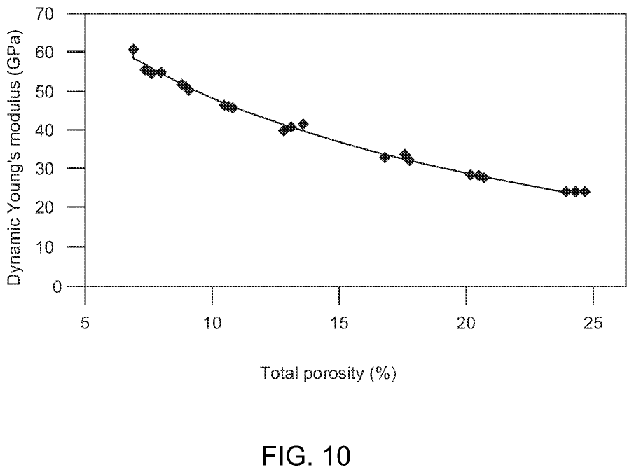

Technical grade tile performance with firing temperature to achieve highest quality could be more efficient with addition of glass fiber and lower firing temperature, or glass fiber could enable higher quality with lower cost extrusion process of aesthetic tiles. The porcelain tile fracture behavior depends on the ceramic composition, firing temperature, body thickness, and detail (see FIGS. 7-10). As shown in Tables 2 and 3, firing temperatures above 1,200° C. improve dynamic elastic modulus and strength, while minimizing porosity.

TABLE 2

| Temp. | d | [symbol] | [symbol] | [symbol] | [symbol] | Strength | D [symbol] | [symbol] | ( [symbol] )/ |
|---|---|---|---|---|---|---|---|---|---|
| ( [symbol] ) | ( [symbol] ) | ( [symbol] ) | ( [symbol] ) | ( [symbol] ) | ( [symbol] ) | ( [symbol] ) | ( [symbol] ) | ( [symbol] ) | ( [symbol] ) |
| 1150 | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | 0. [symbol] |
| 1160 | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | 0. [symbol] |
| 1170 | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | 0. [symbol] |
| 1180 | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | 0. [symbol] |
| 1190 | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | 0. [symbol] |
| 1200 | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | 0. [symbol] |
| 1210 | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | 0. [symbol] |
| 1220 | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | 0. [symbol] |
| 1230 | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | [symbol] ± [symbol] | 0. [symbol] |

[symbol]

indicates data missing or illegible when filed

TABLE 3

| Temperature | Bulk density | True density | Total porosity |
|---|---|---|---|
| (° C.) | (g/cm³) | (g/cm³) | (%) |
| 1150 | 2.07 ± 0.0003 | 2.58 ± 0.008 | 24.28 ± 0.37 |
| 1160 | 2.13 ± 0.002 | 2.57 ± 0.005 | 20.43 ± 0.26 |
| 1170 | 2.18 ± 0.003 | 2.56 ± 0.008 | 17.37 ± 0.54 |
| 1180 | 2.25 ± 0.005 | 2.54 ± 0.004 | 13.13 ± 0.38 |
| 1190 | 2.28 ± 0.002 | 2.53 ± 0.002 | 10.73 ± 0.11 |
| 1200 | 2.31 ± 0.004 | 2.52 ± 0.002 | 8.90 ± 0.11 |
| 1210 | 2.31 ± 0.0002 | 2.51 ± 0.004 | 8.92 ± 0.18 |
| 1220 | 2.23 ± 0.004 | 2.50 ± 0.005 | 7.63 ± 0.42 |
| 1230 | 2.33 ± 0.005 | 2.49 ± 0.006 | 6.85 ± 0.03 |

Table 2 shows the change of mechanical properties of a porcelain tile over a temperature range. See S. Kurama et al., J Sci. 25(3): 761-768 (2012); K. Phani, J. Am. Cer. Soc. 90(7): 2165-2171 (2007). Table 3 shows bulk density, true density, and total porosity of the porcelain tile over the temperature range. Id.

Further to these examples, other ceramic-based applications, such as semiconductors, may also benefit from the addition of glass fibers.

It will be appreciated that the scope of the general inventive concepts is not intended to be limited to the particular exemplary embodiments shown and described herein. From the disclosure given, those skilled in the art will not only understand the general inventive concepts and their attendant advantages, but will also find apparent various changes and modifications to the methods and systems disclosed. It is sought, therefore, to cover all such changes and modifications as fall within the spirit and scope of the general inventive concepts, as described and claimed herein, and any equivalents thereof.

1-15. (canceled)

16. A method of enhancing a ceramic article formed from a plurality of materials, the method comprising:
adding glass fibers to the materials;
mixing the materials to distribute the glass fibers within the materials; and
drying the materials to form the ceramic article,
wherein the glass fibers have a fiber length in the range of 0.38 mm to 6.5 mm;
wherein the glass fibers have a fiber diameter in the range of 10 μm to 25 μm;
wherein the glass fibers have an aspect ratio greater than 100;
wherein the glass fibers have 0.15% to 0.5.% by dry weight of sizing solids; and
wherein the glass fibers have a moisture content of 6% to 12%.

17. The method according to claim 16, wherein the materials form a slurry,
wherein the slurry includes 72-75 wt. % solids, the solids comprising 20-30% ball clay, 25-35% kaolin, 30-35% feldspar, and 15-20% flint, and
wherein the slurry includes 25-28 wt. % water content.

18. The method according to claim 16, wherein the glass fibers constitute 0.3 wt. % to 0.7 wt. % of the materials.

19. The method according to claim 16, wherein the glass fibers constitute 0.5 wt. % of the materials.

20. A ceramic article formed from a plurality of materials, the ceramic article further characterized by the addition of glass fibers to the materials,
wherein the glass fibers have a fiber length in the range of 0.38 mm to 6.5 mm;
wherein the glass fibers have a fiber diameter in the range of 10 μm to 25 μm;
wherein the glass fibers have an aspect ratio greater than 100; and
wherein the glass fibers have 0.15% to 0.5.% by dry weight of sizing solids.

21. The ceramic article according to claim 20, wherein the glass fibers have a moisture content of 6% to 12%.

22. The ceramic article according to claim 20, wherein the materials form a slurry.

23. The ceramic article according to claim 22, wherein the slurry includes 72-75 wt. % solids, the solids comprising 20-30% ball clay, 25-35% kaolin, 30-35% feldspar, and 15-20% flint, and
wherein the slurry includes 25-28 wt. % water content.

24. The ceramic article according to claim 20, wherein the glass fibers constitute 0.3 wt. % to 0.7 wt. % of the materials.

25. The ceramic article according to claim 20, wherein the glass fibers constitute 0.5 wt. % of the materials.

26. The ceramic article according to claim 20, wherein the glass fibers are made from ECR glass.

27. The ceramic article according to claim 20, wherein the glass fibers are made from H glass.
